(19) United States
(12) Patent Application Publication
(10) Pub. No.: US 2022/0137530 A1
(43) Pub. Date: May 5, 2022

(54) IMAGING SYSTEM WITH NON-MAGNETIC REGULATOR AND SECONDARY REGULATOR

(71) Applicant: Hewlett-Packard Development Company, L.P., Spring, TX (US)

(72) Inventors: Kiyofumi Morimoto, Yokohama (JP); Kazuhiko Takemoto, Yokohama (JP)

(73) Assignee: Hewlett-Packard Development Company, L.P., Spring, TX (US)

(21) Appl. No.: 17/414,916

(22) PCT Filed: Jun. 17, 2020
(86) PCT No.: PCT/US2020/038138

§ 371 Date: Jun. 16, 2021

(30) Foreign Application Priority Data
Jun. 18, 2019 (JP) 2019-112633

(51) Int. Cl. G03G 15/08

(52) U.S. Cl. CPC G03G 15/0812; G03G 15/0893

(57) ABSTRACT

An imaging system includes a stirring device to stir a developer, a rotatable developer carrier to carry the developer a non-magnetic regulator, a secondary regulator, an excess developer conveyance path extending from the developer carrier and between the non-magnetic regulator and the secondary regulator, a toner supply path to supply a toner to the stirring device, and a merging portion where the toner supply path and the excess developer conveyance path merge. The non-magnetic regulator and the secondary regulator regulate the thickness of the developer carried by the developer carrier. Excess developer from the developer carrier is conveyed via the excess developer conveyance path. The merging region controls the supply of the toner from the toner supply path to the stirring device based, at least in part, on an amount of the excess developer received from the excess developer conveyance path.

### BACKGROUND

In some imaging apparatuses, a developing device may include a toner density sensor detecting a toner density and a toner supply roller adjusting a toner supply amount. Such a developing device adjusts the toner density of the developer by driving the toner supply roller in response to the toner density detected by the toner density sensor.

### BRIEF DESCRIPTION OF DRAWINGS

FIG. 1 is a schematic diagram of an example imaging apparatus.

FIG. 2 is a schematic cross-sectional view of an example developing device.

FIG. 3 is a schematic cross-sectional view of an example developing device, illustrating a developer carrier, a stirring device, an excess developer conveyance path, and a toner drop port.

FIG. 4 is a schematic cross-sectional view of an example developing device, illustrating a developer carrier, a stirring device, an excess developer conveyance path, and a toner drop port.

FIG. 5 is a schematic enlarged partial view illustrating of components of a developing device including a developer carrier, a non-magnetic regulator, and a secondary regulator.

FIG. 6 is a schematic cross-sectional view of the developing device of FIG. 2, illustrating a state when the toner density is low.

FIG. 7 is a schematic cross-sectional view of the developing device of FIG. 2, illustrating a state when the toner density is high.

FIG. 8 is a graph showing a relationship between a developer passage amount and a toner density.

FIG. 9 is a graph showing a relationship between a developer passage amount and a toner density.

FIG. 10 is a graph showing a relationship between an excess developer amount and a toner density.

FIG. 11 is a graph showing a relationship between an excess developer amount and a toner density.

FIG. 12 is a graph showing a relationship between a toner density and a retention amount of a toner drop port,

FIG. 13 is a schematic cross-sectional view of an example developing device.

FIG. 14 is a schematic cross-sectional view of the example developing device of FIG. 13, illustrating a state when the toner density is low.

FIG. 15 is a schematic cross-sectional view of the example developing device of FIG. 13, illustrating a state when the toner density is high.

FIG. 16 is a graph showing a relationship between a developer passage amount and a toner density.

FIG. 17 is a graph showing a relationship between an excess developer amount and a toner density.

### DETAILED DESCRIPTION

In the following description, with reference to the drawings, the same reference numbers are assigned to the same components or to similar components having the same function, and overlapping description is omitted. An imaging system may be an imaging apparatus such as a printer or a developing device used in the imaging apparatus.

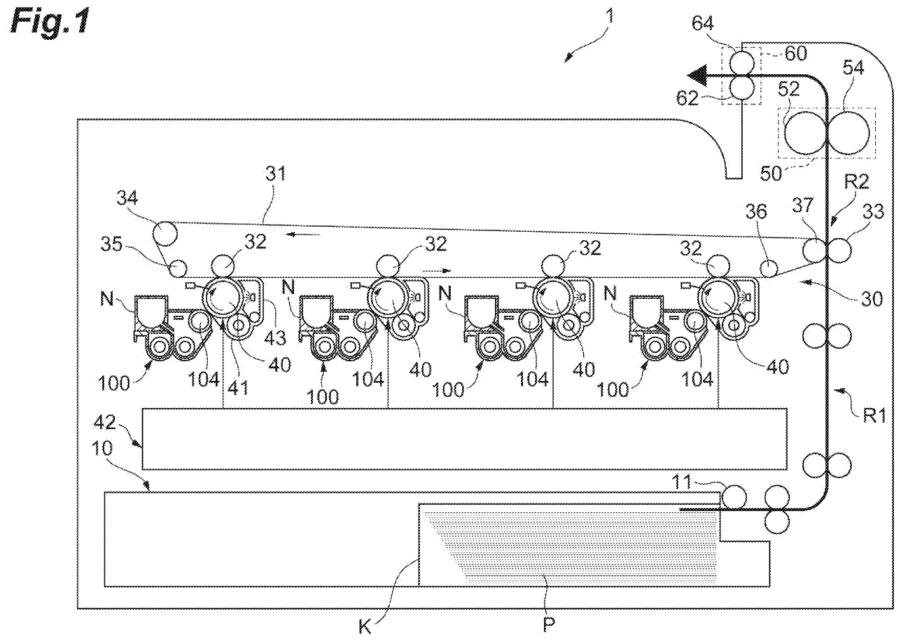

With reference to FIG. 1, an example imaging apparatus 1 illustrated in FIG. 1 is an apparatus which forms a color image by using four colors of magenta, yellow, cyan, and black. The imaging apparatus 1 may include a conveying device 10 which conveys a sheet P corresponding to a recording medium, a developing device 100 which develops an electrostatic latent image, a transfer device 30 which secondarily transfers a toner image onto the sheet P, an image carrier 40 which forms an electrostatic latent image on a surface (a peripheral surface), a fixing device 50 which fixes the toner image onto the sheet P, and a discharging device 60 which discharges the sheet P.

The conveying device 10 conveys the sheet P which is a recording medium having an image formed thereon on a conveyance path R1. The sheets P are stacked and accommodated in a cassette K and are picked up and conveyed by a feeding roller 11. The conveying device 10 causes the sheet P to reach a transfer nip region R2 through the conveyance path R1 at a timing in which the toner image transferred onto the sheet P reaches the transfer nip region R2.

Four developing devices 100 are provided so as to correspond respectively to the four colors. Each developing device 100 may include a developer carrier 104 which carries a toner on the image carrier 40. In the developing device 100, a two-component developer including a toner and a carrier may be used as the developer. The toner and the carrier (e.g., toner particles and carrier particles) may be adjusted to have a desired mixing ratio and may be further stirred and mixed so as to uniformly disperse the toner. Accordingly, the developer may be adjusted to have an optimal charged amount. The developer may be carried by the developer carrier 104, and when the developer is conveyed to a developing region where the developer carrier 104 faces the image carrier 40, by the rotation of the developer carrier 104, the toner in the developer carried by the developer carrier 104 may be transferred onto the electrostatic latent image formed on a peripheral surface of the image carrier 40 so as to develop the electrostatic latent image.

The transfer device 30 may convey the toner image formed by the developing device 100 to the transfer nip region R2 in which the toner image is secondarily transferred onto the sheet P. The example transfer device 30 includes a transfer belt 31 to which the toner image is primarily transferred from the image carrier 40, tension rollers 34, 35, 36, and 37 which tension the transfer belt 31, a primary transfer roller 32 which presses the transfer belt 31 against the image carrier 40, and a secondary transfer roller 33 which presses the transfer belt 31 against the tension roller 37.

The example transfer belt 31 is an endless belt which is moved in a circulating manner by the tension rollers 34, 35, 36, and 37. The tension rollers 34, 35, 36, and 37 each have a rotation axis, and are rotatable about their respective axes. The tension roller 37 is a drive roller which rotates about an axis in a driving manner and the tension rollers 34, 35, and 36 are driven rollers which rotate in accordance with the rotational driving of the tension roller 37. The primary transfer roller 32 is provided to press the transfer belt against the image carrier 40 from the inner peripheral side of the transfer belt 31. The secondary transfer roller 33 is disposed in parallel to the tension roller 37 with the transfer belt 31 interposed therebetween and is provided to press the transfer belt 31 against the tension roller 7 from the outer peripheral side of the transfer belt 31. Accordingly, the secondary transfer roller 33 forms a transfer nip region R2 between the transfer belt 31 and the secondary transfer roller.

The image carrier 40 may also be referred to as an electrostatic latent image carrier, a photosensitive drum, or the like. Four image carriers 40 are provided so as to correspond to the respective four colors. The image carriers 40 may be provided in the movement direction of the transfer belt 31 (e.g., along a path of the transfer belt 31). The developing device 100, a charging roller 41, an exposure unit (or exposure device) 42, and a cleaning unit (cleaning device) 43 may be provided around the circumference of the image carrier 40.

The example charging roller 41 uniformly charges a surface of the image carrier 40 to a predetermined potential. The charging roller 41 moves to follow the rotation of the image carrier 40. The example exposure unit or device 42 exposes the surface of the image carrier 40 charged by the charging roller 41 in response to an image formed on the sheet P. Accordingly, a potential of a portion exposed by the exposure unit 42 in the surface of the image carrier 40 is modified so that the electrostatic latent image is formed. Four developing devices 100 develop the electrostatic latent images formed on the image carriers 40 by the toners supplied from the toner tanks N attached to the respective developing devices 100 so that the toner image is generated. The toner tanks N are respectively filled with the toners of magenta, yellow, cyan, and black. The cleaning unit (or cleaning device) 43 collects the toner remaining on the image carrier 40 after the toner image formed on the image carrier 40 is primarily transferred onto the transfer belt 31.

The fixing device 50 causes the sheet P to pass through a fixing nip region for heating and pressing the sheet so that the toner image secondarily transferred from the transfer belt 31 onto the sheet P is attached and fixed onto the sheet P. The fixing device 50 includes a heating roller 52 which heats the sheet P and a pressing roller 54 which rotates in a driving manner while pressing against the heating roller 52. The heating roller 52 and the pressing roller 54 may have a cylindrical shape and the heating roller 52 may include a heat source such as a halogen lamp provided therein. A fixing nip region, which is a contact region, is provided between the heating roller 52 and the pressing roller 54, and the sheet P may pass through the fixing nip region so that the toner image is melted and fixed onto the sheet P.

The discharging device 60 may include discharging rollers 62 and 64 which discharge the sheet P having the toner image fixed thereto by the fixing device 50 to the outside of the apparatus.

An example printing process of the imaging apparatus 1 illustrated in FIG. 1, will be described. When an image signal of an image to be recorded is input to the imaging apparatus 1, a control unit (or controller) of the imaging apparatus 1 controls the feeding roller 11 to rotate so as to pick up and convey the sheets P stacked on the cassette K. Then, the surface of the image carrier 40 is uniformly charged to a predetermined potential by the charging roller 41 (a charging operation). Subsequently, the surface of the image carrier 40 is irradiated with a laser light by the exposure unit or device 42 on the basis of a received image signal so that the electrostatic latent image is formed (an exposure operation).

In the example developing device 100, the electrostatic latent image is developed so that the toner image is formed (a developing operation). The toner image which is formed in this way is primarily transferred from the image carrier 40 onto the transfer belt 31 in a region in which the image carrier 40 faces the transfer belt 31 (a transfer operation). The toner images formed on four image carriers 40 are sequentially layered on the transfer belt 31 so that a single composite toner image is formed. Then, the composite toner image is secondarily transferred onto the sheet P conveyed from the conveying device 10 in the transfer nip region R2 in which the tension roller 37 faces the secondary transfer roller 33.

The sheet P onto which the composite toner image is secondarily transferred is conveyed to the fixing device 50. Then, the fixing device 50 melts and fixes the composite toner image onto the sheet P by heating and pressing the sheet P between the heating roller 52 and the pressing roller 54 when the sheet P passes through the fixing nip region (a fixing operation). Subsequently, the sheet P is discharged to the outside of the imaging apparatus 1 by the discharging rollers 62 and 64.

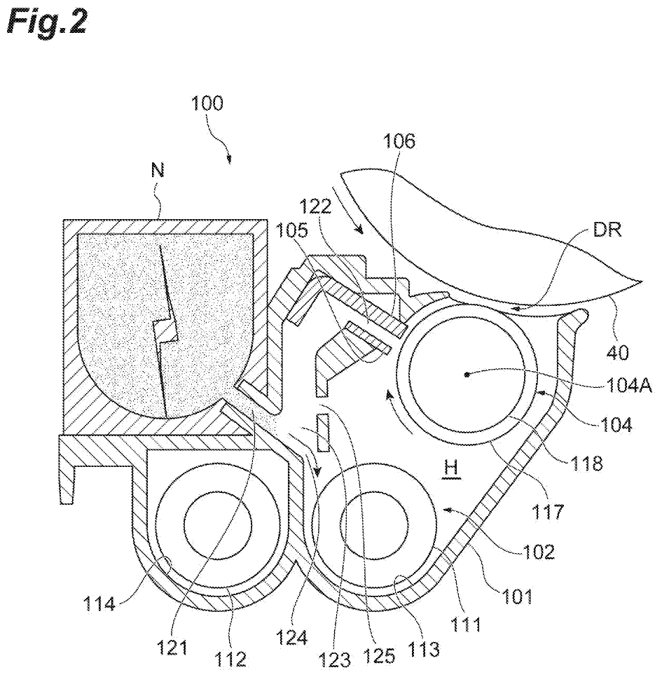

FIG. 2 is a schematic cross-sectional view of an example developing device. The example developing device 100 includes a storage container 101 (or a housing 101), a stirring device 102, a rotatable developer carrier 104, a non-magnetic regulator 105, and a secondary regulator 106.

The storage container 101 stores the developer including the toner and the carrier. That is, the storage container 101 forms a developer storage chamber H to store the developer which may include the toner and the carrier. The storage container 101 houses the stirring device 102, the developer carrier 104, the non-magnetic regulator 105, and the secondary regulator 106. The storage container 101 has an opening at a position in which the developer carrier 104 faces the image carrier 40 and the toner inside the developer storage chamber H is supplied from this opening to the image carrier 40.

With reference to FIGS. 2 to 4, the stirring device 102 includes a first stirring conveyance member 111 and a second stirring conveyance member 112. The first stirring conveyance member 111 and the second stirring conveyance member 112 stir the developer which includes the carrier made of magnetic material, and the toner made of non-magnetic material, so that the carrier and the toner are frictionally charged inside the developer storage chamber H. Further, the first stirring conveyance member 111 and the second stirring conveyance member 112 stir and convey the developer inside the developer storage chamber H. The first stirring conveyance member 111 is disposed in a first conveyance path 113 which is disposed in a lower portion (e.g., bottom portion) of the developer storage chamber H, and the second stirring conveyance member 112 is disposed in a second conveyance path 114 disposed in the lower portion of the developer storage chamber H. The first conveyance path 113 and the second conveyance path 114 extend in a direction parallel to a rotation shaft 104A (or rotational axis) of the developer carrier 104. First end portions of the first conveyance path 113 and the second conveyance path 114 are provided with a first supply port 115 for supplying the developer from the first conveyance path 113 to the second conveyance path 114. Second end portions of the first conveyance path 113 and the second conveyance path 114 are provided with a second supply port 116 for supplying the developer from the second conveyance path 114 to the first conveyance path 113. Then, the first stirring conveyance member 111 conveys the developer of the first conveyance path 113 in a first direction while stirring the developer, and supplies the developer via the first supply port 115 to the second conveyance path 114. The second stirring conveyance member 112 conveys the developer of the second conveyance path 114 in a second direction opposite to the first direction while stirring the developer, and supplies the developer via the second supply port 116 to the first conveyance path 113.

The example developer carrier 104 is disposed to face the image carrier 40 so that a gap is formed between the image carrier 40 and the developer carrier. The developer carrier 104 rotates to carry the developer stirred by the stirring device 102. For example, the developer carrier 104 rotates while carrying the developer stirred by the stirring device 102 on the surface thereof. The image carrier 40 may be rotatably supported in the storage container 101 and may be rotationally driven by a drive source such as a motor. The image carrier 40 may have a cylindrical or columnar shape. The developer carrier 104 may have a cylindrical or columnar shape. The rotation shaft 104A of the developer carrier 104 is parallel to the rotation shaft (or rotational axis) of the image carrier 40, and a gap between the developer carrier 104 and the image carrier 40 is the same in the rotation axis direction of the developer carrier 104. For example, a substantially even gap extends in the direction of the rotational axis between the developer carrier 104 and the image carrier 40. The developer carrier 104 is disposed above the first stirring conveyance member 111. Then, the developer carrier 104 carries on the surface thereof, the developer supplied from the first conveyance path 113. The developer carrier 104 develops the electrostatic latent age of the image carrier 40 by conveying the carried developer along a circumferential path in a conveyance direction, from a region adjacent the first stirring conveyance member 111 to the developing region DR adjacent the image carrier 40. The developing region DR is a region located between the developer carrier 104 and the image carrier 40 and is a region in which the developer carrier 104 faces the image carrier 40. The developing region DR may be a region in which the developer carrier 104 and the image carrier 40 are closest to each other.

The developer carrier 104 includes a developing sleeve 117 which forms a surface layer of the developer carrier 104 and a magnet roller 118 which is disposed inside the developing sleeve 117. The developing sleeve 117 is a cylindrical member formed of a non-magnetic metal. The developing sleeve 117 is rotatable about the rotation shaft that extends along the rotational axis 104A. The developing sleeve 117 may be rotatably supported by the magnet roller 18 and may be driven by a drive source such as a motor. The magnet roller 118 is fixed to the storage container 101 and has a plurality of magnetic poles arranged in the circumferential direction of the developer carrier 104. The developer is carried on the surface of the developing sleeve 117 by the magnetic force of the magnet roller 118. The developer carrier 104 conveys the developer in the rotation direction of the developing sleeve 117 as the developing sleeve 117 rotates.

The developer forms spikes on the developing sleeve 117 according to the magnetic forces of the magnetic poles of the magnet roller 118. The developer carrier 104 causes the spikes of the developer formed by the magnetic poles to contact or approach the electrostatic latent image of the image carrier 40 in the developing region DR between the developer carrier 104 and the image carrier 40. Accordingly, the toner of the developer carried on the developer carrier 104 moves to the electrostatic latent image formed on the peripheral surface of the image carrier 40 so that the electrostatic latent image is developed.

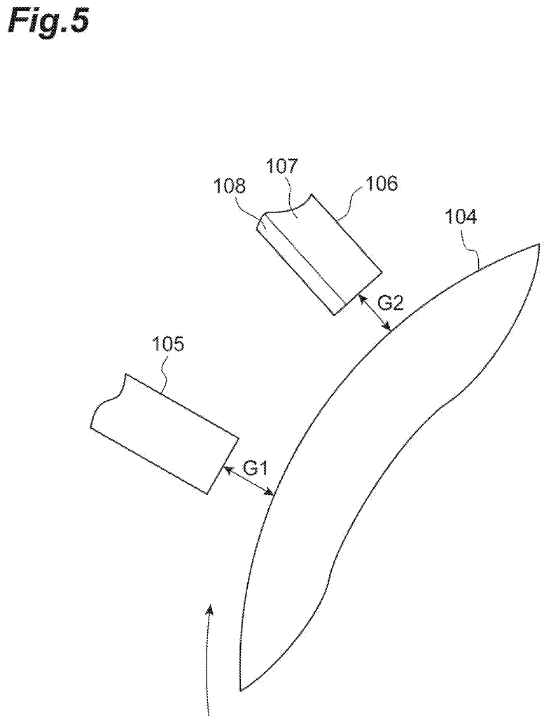

With reference to FIGS. 2 and 5, the non-magnetic regulator 105 may regulate the thickness of the developer carried on the developer carrier 104 and the secondary regulator 106 may further regulate the thickness of the developer carried on the developer carrier 104. The non-magnetic regulator 105 and the secondary regulator 106 may also be referred to as doctors.

The non-magnetic regulator 105 and the secondary regulator 106 may be disposed on the upstream side in the rotation direction of the developing sleeve 117 with respect to the developing region DR between the developer carrier 104 and the image carrier 40. The front ends (or free ends) of the non-magnetic regulator 105 and the secondary regulator 106 on the side of the developer carrier 104 (e.g., ends of the regulators 105, 106 which are closest to the developer carrier 103) are located above the rotation shaft 104A of the developer carrier 104. The secondary regulator 106 is disposed on the downstream side of the non-magnetic regulator 105 in the conveyance direction of the developer around the developer carrier 104 (e.g., along the circumferential path). The non-magnetic regulator 105 is spaced apart from the developing sleeve 117 by a first gap G1, and the secondary regulator 106 is spaced apart from the developing sleeve 117 by a second gap G2 (See FIG. 5). The second gap G2 is smaller than the first gap G1. That is, the second gap G2 is less than the first gap G1. In some examples, the second gap G2 may be the same as the first gap G1. When the developing sleeve 117 rotates, the non-magnetic regulator 105 first regulates the thickness of the developer carried on the peripheral surface of the developing sleeve 117 by the first gap G1 and then the secondary regulator 106 further regulates the thickness of the developer carried on the peripheral surface of the developing sleeve 117 by the second gap G2. For example, the developer carried on the peripheral surface travels to the non-magnetic regulator 105 which allows passage of a thickness of developer corresponding to the first gap G1 and blocks the passage of excess developer that exceeds the thickness. Similarly, the secondary regulator 106 allows passage of a thickness of developer corresponding to the second gap G2, and blocks the passage of excess developer that exceeds that thickness. Accordingly, the excess developer which passes beyond the non-magnetic regulator 105 and is regulated (or blocked) by the secondary regulator 106 is accumulated (or collected) between the non-magnetic regulator 105 and the secondary regulator 106.

The non-magnetic regulator 105 is a regulator which does not have magnetism. The non-magnetic regulator 105 may be formed of any non-magnetic material having any suitable shape or structure. For example, the non-magnetic regulator 105 may contain a stainless-steel material such as SUS304 or a resin material such as ABS is used. Further, the non-magnetic regulator 105 may be formed as a single member (e.g., a single component) or a plurality of members (e.g., an assembly of components).

The secondary regulator 106 may be formed of any suitable material in any suitable shape or structure. The secondary regulator 106 may be magnetic (e.g., may have magnetism), in some examples, or may be non-magnetic (e.g., without magnetism), in other examples. For example, the secondary regulator 106 having magnetism may include a material such as SUS430 or the like. Further, a secondary regulator 106 without magnetism may include a material such as SUS304 or the like. The secondary regulator 106 may be formed as a single member (e.g. a single component) or a plurality of members (e.g., an assembly of components). With reference to FIG. 5, a non-magnetic member 107 may be bonded to a magnetic member 108 to form the secondary regulator 106 that is a magnetic body.

With reference to FIG. 2, the developing device 100 may be provided with a toner supply path 121, an excess developer conveyance path 122, and a merging portion (or merging region) 123.

The toner supply path 121 is a supply path for supplying the toner from the toner tank N which is connected to the developing device 100, to the stirring device 102 in the developer storage chamber H. The toner supply path 121 extends from the toner tank N toward the stirring device 102.

The excess developer conveyance path 122 is a conveyance path which communicates or connects with the gap between the non-magnetic regulator 105 and the secondary regulator 106 and conveys the excess developer that is removed from the developer carrier 104. For example, the excess developer conveyance path 122 extends from the developer carrier 104 through the gap between the non-magnetic regulator 105 and the secondary regulator 106 and conveys the excess developer from the developer carrier 104. In some examples, the excess developer conveyance path 122 is delimited by the non-magnetic regulator 105 and the secondary regulator 106, exclusively. In some examples, the excess developer conveyance path 122 may be formed by or delimited by the non-magnetic regulator 105 and the secondary regulator 106 in combination with other members such as the storage container 101.

The merging portion 123 is a region where the toner supply path 121 merges with the excess developer conveyance path 122. For example, the excess developer conveyance path 122 merges with the toner supply path 121 at the merging portion or region 123. The excess developer conveyance path 122 includes a first portion (e,g., first conveyance path) that extends away upwardly from the developer carrier 104, and a second portion (e.g., second conveyance path) which extends downward from the first conveyance path and reaches the merging portion 123. The merging portion 123 is located at a lower position than the rotation shaft 104A (or lower than the rotational axis 104A) of the developer carrier 104. As will be described later, the merging portion 123 controls the amount of the toner supplied from the toner supply path 121 to the stirring device 102 based, at least in part, on the amount of the excess developer supplied from the excess developer conveyance path 122. For example, the merging portion 123 may control the amount of the toner supplied from the toner supply path 121 to the stirring device 102 based, at least in part, on the amount of the excess developer conveyed by the excess developer conveyance path 122.

With reference to FIGS. 2 to 4, the toner supply path 121 is provided with a toner drop port 124 which is disposed near the stirring device 102 in relation to the merging portion 123 and above the stirring device 102, e.g., at a position higher than the stirring device 102, or an elevated position relative to the stirring device 102. For example, the toner drop port 124 is located between the merging portion 123 and the first stirring conveyance member 111, and located above the first stirring conveyance member 111. The toner drop port 124 is an opening from which the toner supplied from the toner supply path 121 and the excess developer conveyed from the excess developer conveyance path 122 are dropped toward the stirring device 102.

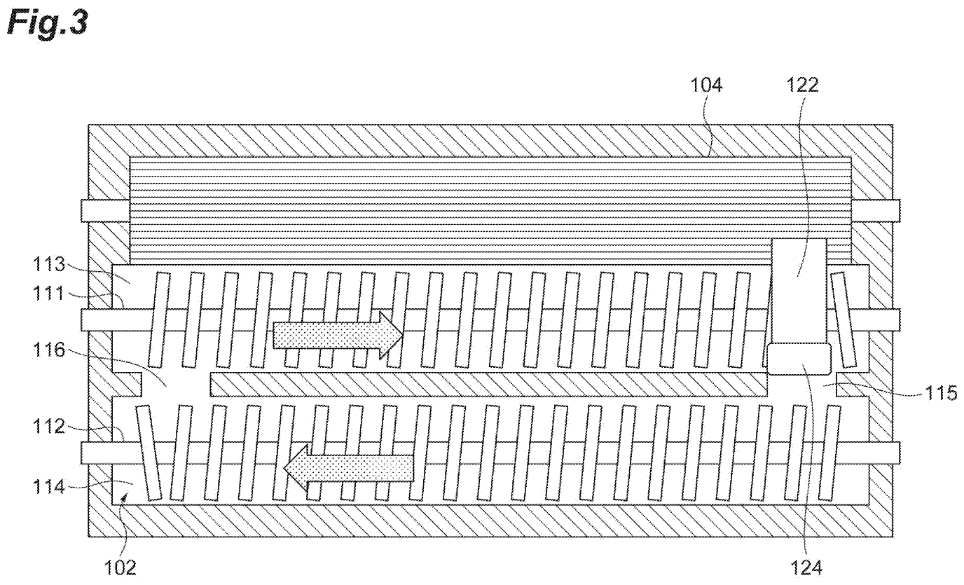

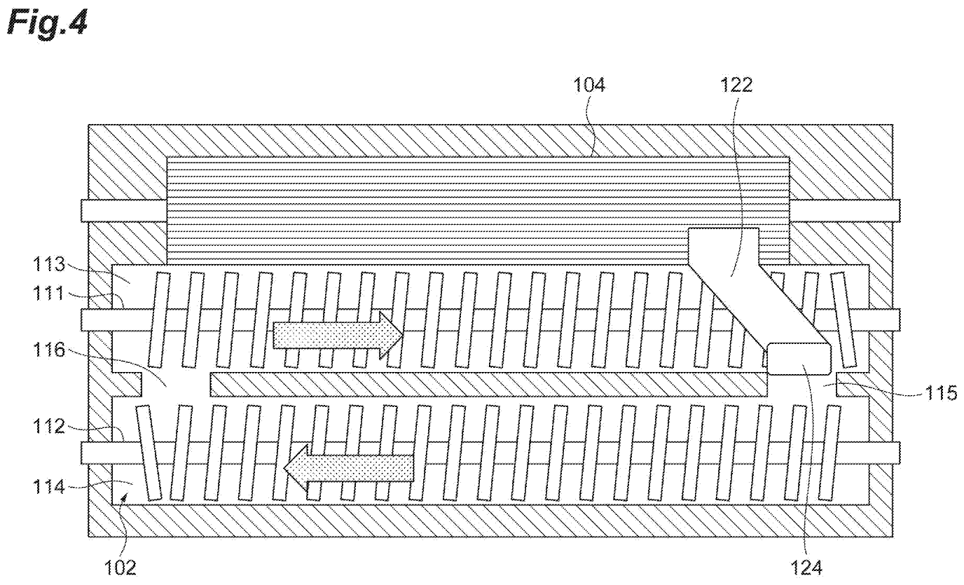

The toner drop port 124 may be disposed, for example, above the first supply port 115, with reference to FIGS. 3 and 4. In the stirring device 102, the developer is stirred by the first stirring conveyance member 111 and the second stirring conveyance member 112 and circulates along the first conveyance path 113, the first supply port 115, the second conveyance path 114, and the second supply port 116. The developer may then be transferred to the developer carrier 104 while being conveyed along the first conveyance path 113. The toner drop port 124 may be disposed above the first supply port 115 to direct the toner and the excess developer dropped from the toner drop port 124 to the first supply port 115, and to sufficiently stir the toner and excess developer by way of the second stirring conveyance member 112 in the second conveyance path 114, prior to being carried on the developer carrier 104.

Further, the toner drop port 124 may be disposed at a position that is aligned with (e.g., overlapping) the developer carrier 104 in the axial direction of the developer carrier 104, in some examples (with reference to FIG. 3), or at a position that is offset from the developer carrier 104 in the axial direction of the developer carrier 104 in other examples, (with reference to FIG. 4). The toner drop port 124 may be disposed at the position that is aligned with the developer carrier 104 in the axial direction of the developer carrier 104 to reduce the size of the developing device 100 (e.g., to achieve a more compact size of the developing device 100). The toner drop port 124 may be disposed at the position that is offset with respect to the developer carrier 104 in the axial direction of the developer carrier 104 to suppress the toner and the excess developer dropped from the toner drop port 124 from being carried on the developer carrier 104 before the toner and the excess developer are sufficiently stirred together.

The toner drop port 124 may be narrower than the excess developer conveyance path 122. For example, the toner drop port 124 may form an opening in the merging portion, having a cross-sectional area that is less than a smallest cross-sectional area of the conveyance path 122. Accordingly, when the amount of the excess developer conveyed from the excess developer conveyance path 122 to the merging portion 123 increases, the amount of the toner supplied from the toner supply path 121 to the stirring device 102 decreases. Further, when the amount of the excess developer conveyed from the excess developer conveyance path 122 to the merging portion 123 increases more than a passageable amount of the toner that can pass through the drop port 124 (e.g., a flow rate of the toner through the drop port 124), the excess developer is accumulated in the merging portion 123 and the toner supply path 121 is inhibited from supplying toner to the stirring device 102.

The excess developer conveyance path 122 may be provided with an overflow port 125 disposed near the developer carrier 104 in relation to the merging portion 123, For example, the excess developer conveyance path 122 may extend from an inlet adjacent the developer carrier 104 to an outlet at the merging portion 123, and the overflow port 125 may be located between the inlet and the outlet along the excess developer conveyance path 122. The overflow port 125 is an opening through which the excess developer of the excess developer conveyance path 122 accumulated in the merging portion 123 is discharged. The excess developer is discharged from the excess developer conveyance path 122 through the overflow port 125, to the stirring device 102. When the excess developer accumulated in the merging portion 123 reaches a threshold amount, the amount of developer supplied to the stirring device 102 may be insufficient, which may affect the development quality of the electrostatic latent image on the image carrier, and the printing quality of the imaging apparatus. Accordingly, the overflow port 125 is formed in the excess developer conveyance path 122 to discharge a part of the excess developer from the excess developer conveyance path 122 to the stirring device 102, in order to supply a suitable amount of developer to the stirring device 102.

Experimentation that was carried out, in order to examine a relationship of the magnetism of the regulator, the toner density of the developer, and the amount of the developer passing beyond the regulator in the developing device 100, will be described.

In a first experiment (Experiment 1), the developing device 100 is provided with a regulator constituted by the non-magnetic regulator 105 by removing the secondary regulator 106. When the non-magnetic regulator 105 was used, the first gap G1 between the non-magnetic regulator 105 and the developer carrier 104 was set to 0.9 mm, and the developer carrier 104 had an outer diameter of 18.2 mm and was rotated at the rotation speed of 400 rpm. The carrier particles in the developer had a bulk density of 2.28 g/cm³, a flow rate of 30.3 s/50 g, an average particle size of 36.8 μm, a magnetic property of 1.1 MA/m, a saturation magnetization of 79 Am²/kg, a residual magnetization of 0.7 Am²/kg, and a holding force of 0.8 kA/m.

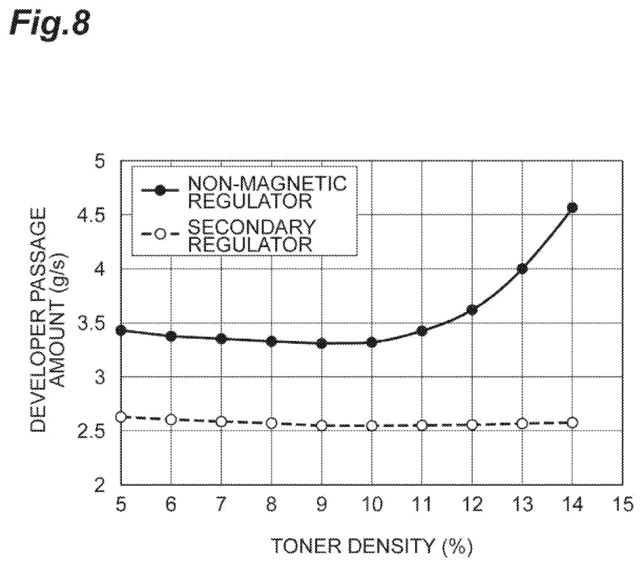

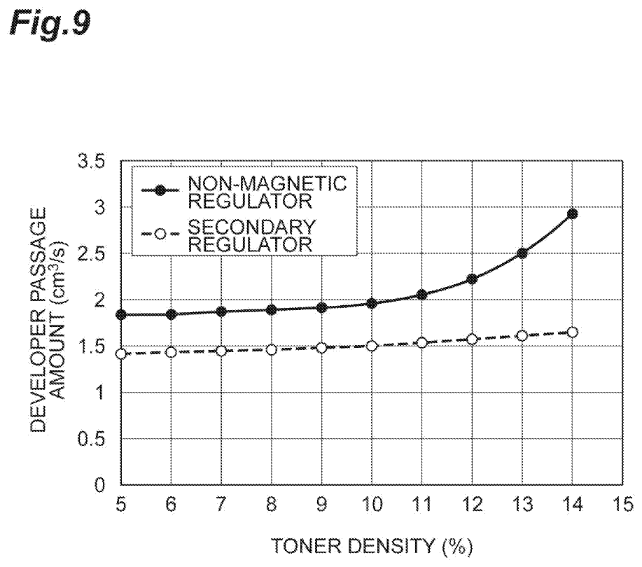

The developer regulated (e.g., blocked) by the non-magnetic regulator 105 was collected from the developer carrier 104 after the rotation of the developer carrier 104 was stopped, and the toner density (%) of the developer and the developer flow rate (g/s) (e.g., (e.g., developer passage amount) of the carried developer passing beyond the non-magnetic regulator 105 were measured. The toner density is a ratio of the toner with respect to the carrier of the developer. Accordingly, the toner density increases when the ratio of the toner increases and the ratio of the carrier decreases, and the toner density decreases when the ratio of the toner decreases and the ratio of the carrier increases. The toner density was measured by a suction-type small-sized charge amount measuring device (Model No.: 210HS) manufactured by Trek Japan Co., Ltd. In the measurement of the developer passage amount (g/s), the developer carried on a predetermined area of the outer peripheral surface of the developer carrier 104 was collected and the weight (g/cm²) of the collected developer per unit area and the surface speed (cm²/s) per unit area of the developer carrier 104 were obtained. The developer passage amount (g/s) was obtained by multiplying the weight of the developer per unit area by the surface speed per unit area of the developer carrier 104. The results of Experiment 1 are shown in FIG. 8, and the results obtained by converting the developer passage amount from the weight (g/s) to the volume (cm³/s) are shown in FIG. 9.

In a second experiment (Experiment 2), the developing device 100 had a regulator constituted of the secondary regulator 106. With reference to FIG. 5, the non-magnetic member 107 was bonded to the magnetic member 108 to form the secondary regulator 106. The second gap G2 between the secondary regulator 106 and the developer carrier 104 was set to 0.7 mm. The other conditions were the same as those described for Experiment 1. The developer regulated (or blocked) by the secondary regulator 106 was collected from the developer carrier 104 after the rotation of the developer carrier 104 was stopped, and the toner density (%) and the developer passage amount (g/s) of the carried developer passing beyond the secondary regulator 106 were measured. The results of Experiment 2 are shown in FIG. 8 and the results obtained by converting the developer passage amount from weight (g/s) to volume (cm³/s) are shown in FIG. 9.

Based on the results shown in FIGS. 8 and 9, the developer passage amount of the secondary regulator 106 remains substantially the same (e.g., does not change) even when the toner density is changed. However, the developer passage amount of the non-magnetic regulator 105 increased when the toner density exceeded a predetermined range.

The experiment was carried out a plurality of times by changing a condition. Here, when a developer having poor fluidity was used, the steep increase in the developer passage amount of the non-magnetic regulator 105 became increasingly noticeable (noticeably occurred) as the toner density exceeded a threshold range. Further, this phenomenon occurred noticeably when the second gap G2 between the secondary regulator 106 and the developer carrier 104 was wide. Accordingly, since the spikes of the developer are cut by the non-magnetic regulator 105 while the carrier particles are arranged in a chain shape under the influence of the magnetic restraint of the developer carrier 104 (the magnet roller 118), the amount of the developer passing through the first gap G1 remains substantially low. However, when the toner density increases, a distance between the carrier particles increases and hence the influence of the magnetic restraint of the developer carrier 104 decreases. For this reason, since the spikes of the developer wrap around the non-magnetic regulator 105, it is assumed that the amount of the developer passing through the second gap G2 increases. Meanwhile, since a distance between the carrier particles increases when the toner density increases and the magnetic restraint of the secondary regulator 106 is exhibited in the second gap G2, it is assumed that the amount of the developer passing through the first gap G1 is relatively low.

The influence of the magnetic restraint of the developer carrier 104 is large in the vicinity of the outer peripheral surface of the developer carrier 104. For this reason, when the second gap G2 was small, the developer passage amount of the secondary regulator 106 substantially did not increase even when the toner density increased or the non-magnetic regulator was used as the secondary regulator 106. When the second gap G2 was 0.6 mm or less, an increase in the developer passage amount of the secondary regulator 106 could be suitably suppressed even when the toner density increased or the non-magnetic regulator was used as the secondary regulator 106.

Furthermore, the toner density at which the amount of the developer passing through the second gap G2 starts to increase may be changed by changing the size of the second gap G2 or the fluidity of the developer.

Accordingly, in the developing device 100 in which the non-magnetic regulator 105 and the secondary regulator 106 are provided as regulators, the amount of the excess developer increases when the toner density exceeds a predetermined range or a threshold value. For this reason, it is possible to achieve a self-adjustment of the toner supply amount in the merging portion 123 by conveying the excess developer to the merging portion 123. In addition, it is possible to improve the self-adjustment of the toner supply amount by using a magnetic regulator as the secondary regulator 106. In addition, it is possible to achieve a similar performance of self-adjustment of the toner supply amount with a non-magnetic regulator provided as the secondary regulator 106 when the second gap G2 is 0.6 mm or less. In addition, it is possible to appropriately maintain the toner density within a predetermined range by setting the opening area or the opening shape of the toner drop port 124 so that the amount of the excess developer conveyed from the excess developer conveyance path 122 to the merging portion 123 exceeds the passageable amount of the toner drop port 124 when the toner density is a set range or more in some examples, or when the toner density exceeds a threshold according to other examples.

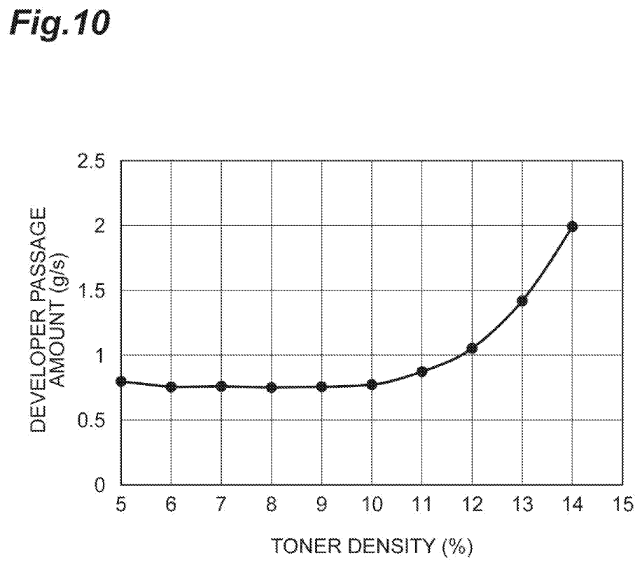

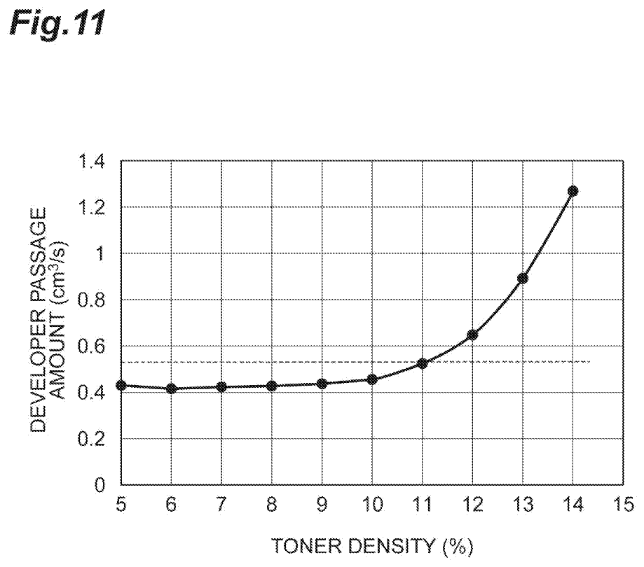

A difference (g/s) of the developer passage amount (g/s) in which the developer passed through the non-magnetic regulator 105 in Experiment 1 (see FIG. 8) and the developer passage amount (g/s) in which the developer passed through the secondary regulator 106 in Experiment 2 (see FIG. 8) was obtained as the excess developer amount. The obtained difference is shown in FIG. 10 and a result obtained by converting this difference from the weight (g/s) into the volume (cm³/s) is shown in FIG. 11. In FIG. 11, the passageable amount of the toner drop port 124 is indicated by a dashed line.

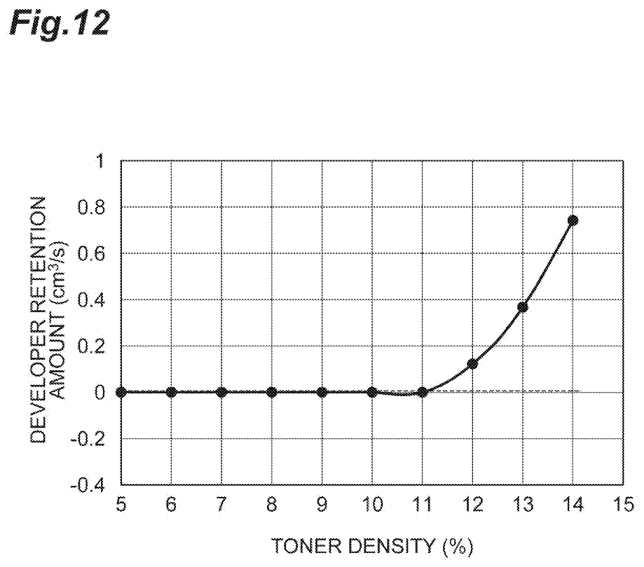

In a third experiment (Experiment 3), the developing device 100 provided with both of the non-magnetic regulator 105 and the secondary regulator 106 as the regulators was prepared and the passageable amount of the toner drop port 124 was set as the excess developer amount in the case of the toner density of 11%. The other conditions were the same as those described for Experiments 1 and 2. Then, the developer retention amount (cm³/s) of the excess developer staying in the merging portion 123 was measured after the rotation of the developer carrier 104 was stopped. The measurement results are shown in FIG. 12.

As shown in FIGS. 11 and 12, the amount of the excess developer starts to gradually increase when the toner density is about 9% and the increase rate abruptly increases when the toner density is about 11%. When the toner density was less than 11% the excess developer did not stay at the merging portion 123 and the toner drop port 124 was opened. The toner was then supplied from the toner supply path 121 so that the toner density increased. Meanwhile, when the toner density exceeded 11% the excess developer stayed at the merging portion 123 and the toner drop port 124 was closed. Then, the supply of the toner from the toner supply path 121 was stopped so that the toner density decreased. The toner density was maintained at about 11% by the self-adjustment of the toner density.

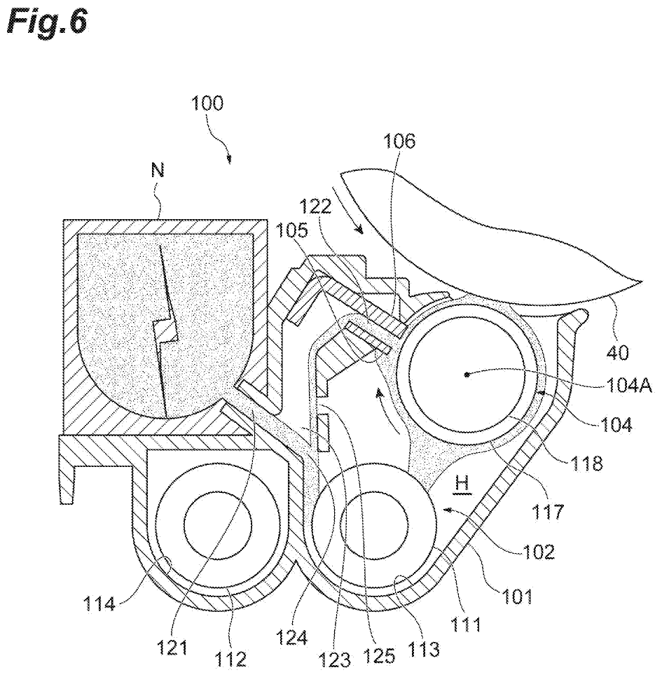

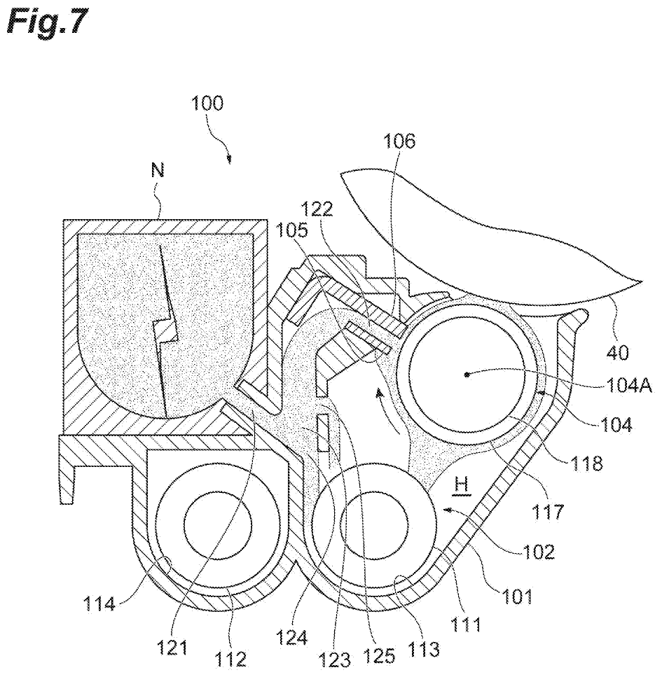

An operation of the developing device 100 when the toner density is low will be described with reference to FIGS. 6 and 7.

With reference to FIG. 6, when the toner density decreases, the amount of the excess developer conveyed from the excess developer conveyance path 122 to the merging portion 123 decreases. For this reason, even when the excess developer is conveyed from the excess developer conveyance path 122 to the merging portion 123, the toner drop port 124 is not closed (or blocked) by the excess developer. Accordingly, the toner is supplied from the toner tank N to the stirring device 102 through the toner supply path 121, the merging portion 123, and the toner drop port 124. Accordingly, the toner density of the developer increases.

With reference to FIG. 7, when the toner density increases, the amount of the excess developer conveyed from the excess developer conveyance path 122 to the merging portion 123 increases. Accordingly, when the excess developer is conveyed from the excess developer conveyance path 122 to the merging portion 123, the amount of the toner supplied from the tank N and passing through the toner drop port 124 decreases. Accordingly, the amount of the toner supplied from the toner supply path 121 to the stirring device 102 decreases so that the toner density of the developer decreases. In addition, when the toner density increases, the amount of the excess developer conveyed from the excess developer conveyance path 122 to the merging portion 123 increases to a larger amount than the passageable amount of the toner drop port 124, and accordingly the excess developer is accumulated in the merging portion 123 and the toner drop port 124 is closed. Accordingly, the toner supply path 121 stops or is inhibited from supplying toner to the stirring device 102, which in turn causes the toner density to decrease.

Accordingly, with reference to FIG. 1, in the example imaging apparatus 1, when the toner density increases, the amount of the excess developer conveyed from the excess developer conveyance path 122 to the merging portion 123 increases so that the excess developer is accumulated in the merging portion 123. Accordingly, since the supply of the toner is suppressed or stopped, the toner density decreases. When the toner density decreases, the amount of the excess developer conveyed from the excess developer conveyance path 122 to the merging portion 123 decreases so that the excess developer is not accumulated in the merging portion 123. Accordingly, since the toner is supplied from the toner supply path 121, the toner density increases. Accordingly, it is possible to carry out the self-adjustment of the toner density.

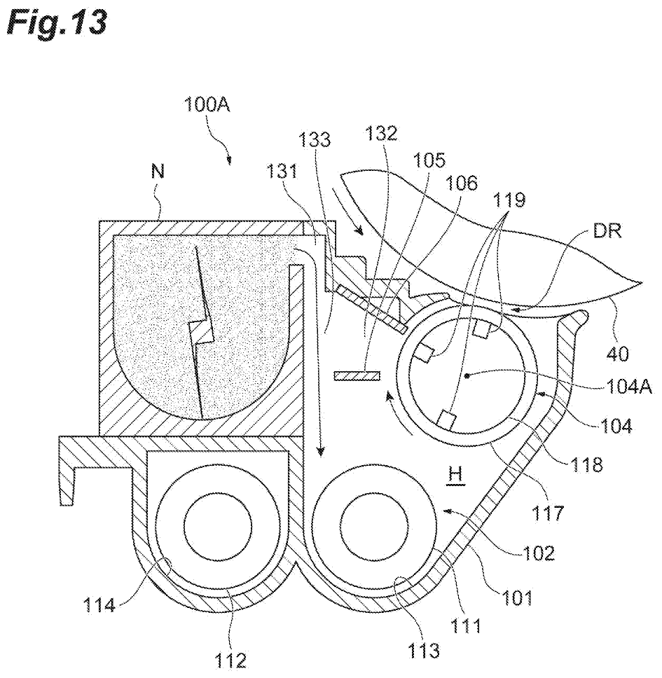

An example developing device 100A illustrated in FIG. 13 is similar to the developing device 100 illustrated in FIG. 2, but differs in the shapes and arrangement of the toner supply path, the excess developer conveyance path, the merging portion, and the like. For this reason, differences from the developing device 100 will be described below and description of features similar to the developing device 100 will be omitted.

The example developing device 100A includes the storage container 101, the stirring device 102, the rotatable developer carrier 104, the non-magnetic regulator 105, and the secondary regulator 106. Further, the developing device 100A is provided with a toner supply path 131, an excess developer conveyance path 132, and a merging portion (or merging region) 133.

The toner supply path 131 is a supply path for supplying the toner from the toner tank N attached to the developing device 100A to the stirring device 102 of the developer storage chamber H. The toner supply path 131 extends from the toner tank N toward the stirring device 102.

The excess developer conveyance path 132 is a conveyance path which communicates or is connected with a gap between the non-magnetic regulator 105 and the secondary regulator 106 and conveys the excess developer. For example, the excess developer conveyance path 132 is a conveyance path which extends from the developer carrier 104 via a gap between the non-magnetic regulator 105 and the secondary regulator 106 and conveys the excess developer from the developer carrier 104. The excess developer conveyance path 132 may be formed between the non-magnetic regulator 105 and the secondary regulator 106 exclusively, in some examples, or may be formed in combination with other members such as the storage container 101, in other examples.

The merging portion 133 is a portion where the toner supply path 131 and the excess developer conveyance path 132 merge. For example, the excess developer conveyance path 132 merges with the toner supply path 131 at the merging portion 133. At least a part of the excess developer conveyance path 132 and the merging portion 133 are disposed under the influence of the magnetic restraint of at least one of magnetic poles 119 of the developer carrier 104. In some examples, one magnetic pole 119 may be disposed at a position facing the secondary regulator 106. In some examples, a plurality of magnetic poles 119 may be disposed in the secondary regulator 106. At least a part of the excess developer conveyance path 132 and the merging portion 133 are disposed at a position in which the excess developer can be adsorbed by at least one of the plurality of magnetic poles 119 of the developer carrier 104. For this reason, at east one of the plurality of magnetic poles 119 of the developer carrier 104 adsorbs and holds a part of the excess developer in at east a part of the excess developer conveyance path 132 and the merging portion 133.

Accordingly, since the amount of the excess developer adsorbed and held by the magnetic pole 119 of the developer carrier 104 is lower when the toner density is relatively low, the merging portion 133 is open and allows passage of the developer. Accordingly, the toner is supplied from the toner supply path 121 to the stirring device 102 so that the toner density increases. When the toner density increases, the amount of the excess developer adsorbed and held by the magnetic pole 119 of the developer carrier 104 increases so that the merging portion 133 is narrowed. Accordingly, the amount of the toner supplied from the toner supply path 121 to the stirring device 102 decreases. At this time, when the excess developer adsorbed and held by the magnetic pole 119 of the developer carrier 104 closes the passage of developer in the merging portion 133, the supply of the toner from the toner supply path 121 to the stirring device 102 is stopped or inhibited.

Accordingly, the merging portion 133 controls the supply of the toner from the toner supply path 131 to the stirring device 102 based, at least in part, on the amount of the excess developer supplied from the excess developer conveyance path 132. Accordingly, the merging portion 133 may control the amount of the toner supplied from the toner supply path 131 to the stirring device 102 on the basis of the amount of the excess developer conveyed by the excess developer conveyance path 132.

Experimentation was carried out in order to examine a relationship of the magnetism of the regulator, the toner density of the developer, and the amount of the developer passing through the regulator in the developing device 100A, will be described.

In an experiment (Experiment 4), a developing device 100A had a regulator constituted of the non-magnetic regulator 105 but not the secondary regulator 106. The first gap G1 between the non-magnetic regulator 105 and the developer carrier 104 was set to 0.9 mm, and the developer carrier 104 had an outer diameter of 18.2 mm and was rotated at the rotation speed of 400 rpm. The carrier particles in the developer had a bulk density of 2.28 g/cm³, a flow rate of 30.3 s/50 g, an average particle size of 36.8 μm, a magnetic property of 1.1 MA/m, a saturation magnetization of 79 Am²/kg, a residual magnetization of 0.7 Am²/kg, and a holding force of 0.8 kA/m.

During the experiment, the developer ha was regulated (or blocked) by the non-magnetic regulator 105 was collected from the developer carrier 104 after the rotation of the developer carrier 104 was stopped, and the toner density (%) of the developer and the developer passage amount (g/s) of the developer passing through the non-magnetic regulator 105 were measured.

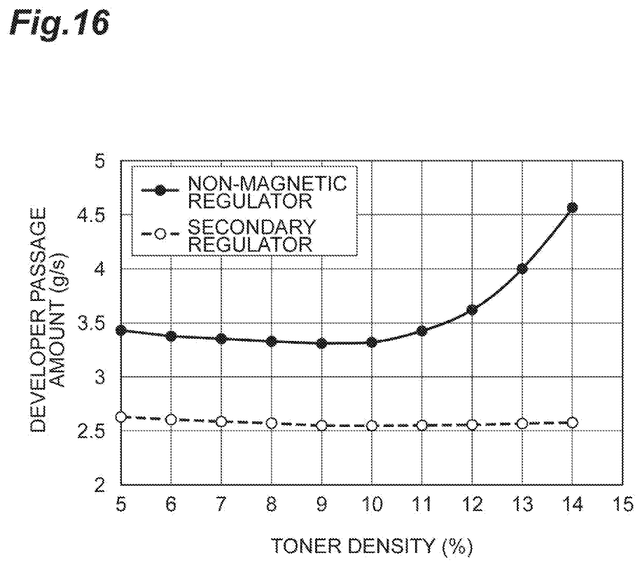

The toner density was measured by a suction-type small-sized charge amount measuring device (Model No.: 210HS) manufactured by Trek Japan Co., Ltd. The developer passage amount (g/s) was measured similarly to Experiment 1. The results of Experiment 4 are shown in FIG. 16.

In another experiment (Experiment 5), the developing device 100A included a regulator constituted of the secondary regulator 106 but not the non-magnetic regulator 105. With reference to FIG. 5, the secondary regulator 106 was obtained by bonding the non-magnetic member 107 to the magnetic member 108, and the second gap G2 between the secondary regulator 106 and the developer carrier 104 was set to 0.8 mm. The other conditions were the same as those of Experiment 4. The developer regulated (or blocked) by the secondary regulator 106 was collected from the developer carrier 104 after the rotation of the developer carrier 104 was stopped, and the toner density (%) and the developer passage amount (g/s) of the secondary regulator 106 were measured. The results of Experiment 5 are shown in FIG. 16.

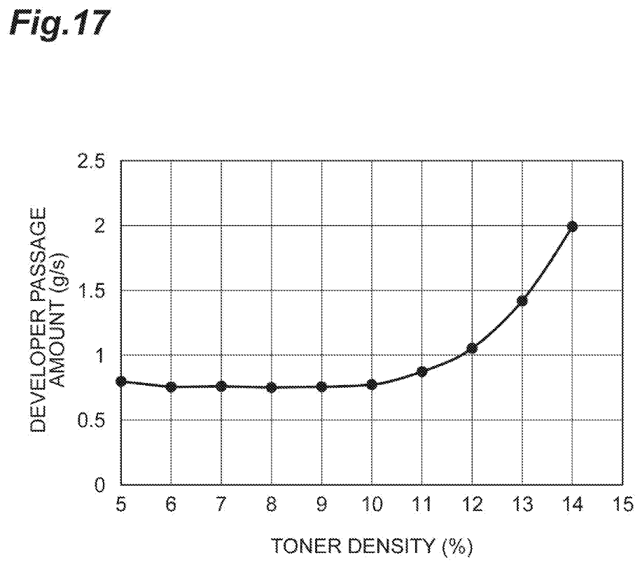

A difference (g/s) of a first developer passage amount (g/s) based on the developer carried on the developer carrier beyond (e.g., downstream of) the non-magnetic regulator 105 in Experiment 4 (see FIG. 16) and a second developer passage amount (g/s) based on the developer carried on the developer carrier 104 beyond (e.g., downstream of) the secondary regulator 106 in Experiment 5 (see FIG. 16) was obtained as the excess developer amount. The difference obtained is shown in FIG. 17.

Based on the results shown in FIGS. 16 and 17, the developer passage amount of the secondary regulator 106 remained substantially stable even when the toner density was changed, but the developer passage amount of the non-magnetic regulator 105 increased when the toner density exceeded a predetermined range.

Accordingly, in the developing device 100A having both the non-magnetic regulator 105 and the secondary regulator 106 as regulators, when the toner density exceeds a predetermined range, the amount of the excess developer increases. The excess developer may be conveyed to the merging portion 133 and may be adsorbed and held by the magnetic pole 119 of the developer carrier 104, in order to impart the merging portion 133 with control (or self-adjustment) of the amount of toner supply. In some examples, the secondary regulator 106 may be a magnetic regulator in order to better control (more appropriately perform the self-adjustment of) the toner supply amount. In some examples, the second gap G2 between the secondary regulator 106 and the developer carrier 104 may be set to 0.6 mm or less, in order to achieve an improved control (to appropriately perform the self-adjustment) of the toner supply amount even when the secondary regulator 106 is a non-magnetic regulator. Further, the adsorption force of the magnetic pole 119 of the developer carrier 104, the arrangement of the merging portion 133, and the like may be set so that the amount of the excess developer conveyed from the excess developer conveyance path 132 to the merging portion 133 is equal to or substantially equal to an amount in which the merging portion 133 is blocked by the excess developer adsorbed by the magnetic pole 119 of the developer carrier 104 when the toner density exceeds a threshold. Accordingly, the toner density can be more suitably kept within a target range (e.g., a predetermined range) below the threshold.

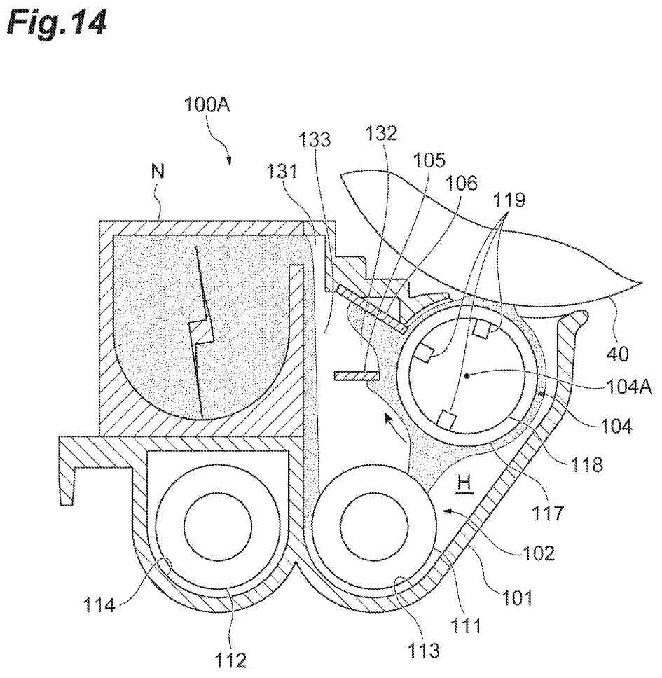

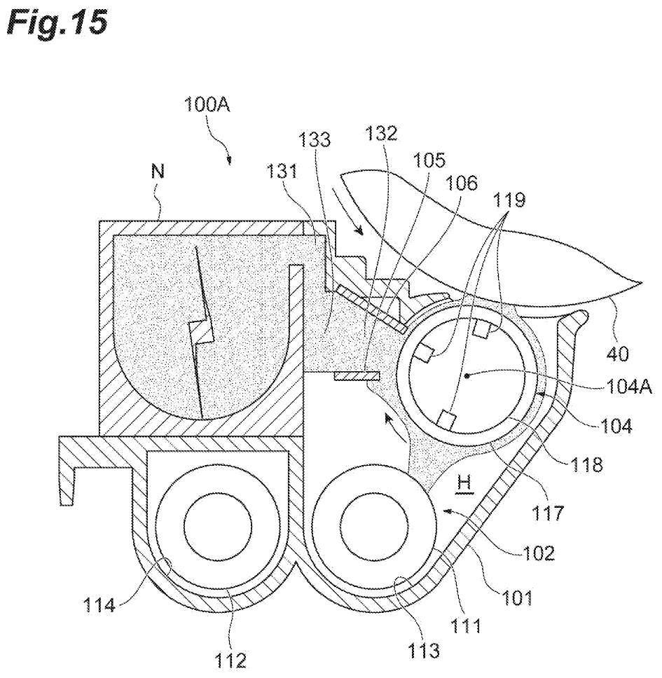

Next, an operation of the developing device 100A when the toner density is low and the toner density is high will be described with reference to FIGS. 14 and 15.

With reference to FIG. 14, when the toner density decreases, the amount of the excess developer conveyed from the excess developer conveyance path 132 to the merging portion 133 decreases. For this reason, the amount of the excess developer adsorbed and held by the magnetic pole 119 of the developer carrier 104 decreases, and consequently the merging portion 133 is opened. Accordingly, the toner is supplied from the toner tank N to the stirring device 102 through the toner supply path 131 and the merging portion 133. Accordingly, the toner density of the developer increases.

As illustrated in FIG. 15, when the toner density increases, the amount of the excess developer conveyed from the excess developer conveyance path 132 to the merging portion 133 increases. For this reason, the amount of the excess developer adsorbed and held by the magnetic pole 119 of the developer carrier 104 increases, and consequently, the opening of the merging portion 133 is narrowed. Therefore, the amount of the toner supplied via the toner supply path 131 to the stirring device 102 decreases which in turn causes the toner density of the developer to decrease. Accordingly, when the toner density increases, the excess developer adsorbed and held by the magnetic pole 119 of the developer carrier 104 collects at the merging portion 133 and tends to close off the merging portion 133, so as to stop or reduce the supply of toner from the toner supply path 121 to the stirring device 102, which in turn causes the toner density to decrease.

With reference to FIG. 13, in the developing device 100A, when the toner density increases, the amount of the excess developer adsorbed and held by the magnetic pole 119 of the developer carrier 104 increases so that the opening of the merging portion 133 is narrowed. Accordingly, the amount of the toner supplied from the toner supply path 131 to the stirring device 102 decreases so that the toner density decreases. Further, when the toner density increases, the excess developer that is adsorbed and held by the magnetic pole 119 of the developer carrier 104 collects at the merging portion 133, and the toner is inhibited or stopped by the excess developer in the merging portion 133, from flowing from the toner supply path 131 to the stirring device 102, which in turn causes the toner density to decrease. When the toner density decreases, the amount of the excess developer adsorbed and held by the magnetic pole 119 of the developer carrier 104 decreases, which may cause the opening between the toner supply path 131 and the merging portion 133 to widen. Consequently, the toner is supplied from the toner supply path 131 to the stirring device 102, which in turn causes the toner density to increase. Accordingly, it is possible to perform the self-adjustment or control of the toner density.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

For example, the adjustment or control of the toner density in the developing device may be achieved by the above-described self-adjustment mechanism, or in other examples, the control of the toner density may be achieved by a combination of the above-described self-adjustment mechanism and other adjustment mechanisms. For example, in an example adjustment mechanism the developer storage chamber H may be provided with a toner density sensor, the toner tank N may be provided with a toner conveying mechanism such as an auger, and the toner conveying mechanism may be driven based on the detection value of the toner density sensor. In another example, the developer storage chamber H may be provided with a toner density sensor, the developing device may be provided with a toner reservoir tank having a toner conveying mechanism such as an auger, and the toner conveying mechanism of the reservoir tank may be driven based on the detection value of the toner density sensor.

1. An imaging system comprising:
a stirring device to stir a developer;
a developer carrier that is rotatable to carry the developer stirred by the stirring device;
a non-magnetic regulator to regulate a thickness of the developer carried by the developer carrier;
a secondary regulator to further regulate the thickness of the developer carried by the developer carrier;
an excess developer conveyance path to convey an excess developer from the developer carrier, the excess developer conveyance path extending from the developer carrier via a gap formed between the non-magnetic regulator and the secondary regulator;
a toner supply path to supply a toner to the stirring device; and
a merging region where the toner supply path and the excess developer conveyance path merge, the merging region to control the supply of the toner from the toner supply path to the stirring device based, at least in part, on an amount of the excess developer received from the excess developer conveyance path.

2. The imaging system according to claim 1, wherein
the secondary regulator is disposed on the downstream side of the non-magnetic regulator in a conveyance direction of the developer around the developer carrier.

3. The imaging system according to claim 1, wherein
the secondary regulator is magnetic.

4. The imaging system according to claim 3, wherein
the secondary regulator comprises a non-magnetic member bonded with a magnetic member.

5. The imaging system according to claim 1, wherein
the non-magnetic regulator is spaced apart from the developer carrier by a first gap, and
the secondary regulator is spaced apart from the developer carrier by a second gap which is smaller than the first gap.

6. The imaging system according to claim 5, wherein
the second gap is approximately 0.6 mm or less.

7. The imaging system according to claim 1, wherein
the toner supply path is provided with a toner drop port which is located between the merging region and the stirring device and located above the stirring device.

8. The imaging system according to claim 7, wherein
the toner drop port has an opening area that is less than a cross-sectional area of the excess developer conveyance path.

9. The imaging system according to claim 7, wherein
when a toner density of the developer is a set range or more, an opening area of the toner drop port is sized so that an amount of the excess developer conveyed from the excess developer conveyance path exceeds an amount of the developer dropped from the toner drop port.

10. The imaging system according to claim 7, wherein
the stirring device extends in an axial direction and,
the toner drop port is disposed above an end portion of the stirring device in the axial direction.

11. The imaging system according to claim 7, wherein
the excess developer conveyance path is provided with an overflow port which is disposed between the developer carrier and the merging region along the excess developer conveyance path.

12. The imaging system according to claim 1, wherein
the developer carrier has a plurality of magnetic poles for carrying the developer, and
the merging region is adjacent at least one of the plurality of magnetic poles, to adsorb the excess developer at the merging region.

13. The imaging system according to claim 12, wherein
the developer carrier includes a rotatable developing sleeve which forms a surface layer of the developer carrier and a magnet roller which is disposed inside the developing sleeve, wherein the magnet roller includes the plurality of magnetic poles arranged in the circumferential direction of the developer carrier, the magnetic poles of the developer carrier to adsorb at least a part of the developer in the merging region.

14. A developing device comprising:
a stirring device to stir a developer;
a toner supply path to supply a toner to the developer stirred by the stirring device;
a rotatable developer carrier to carry the developer stirred received from the stirring device along a circumferential path to a developing region adjacent an image carrier;
a non-magnetic regulator located along the circumferential path to regulate a thickness of the developer carried by the developer carrier; a secondary regulator located between the non-magnetic regulator and the developing region along the circumferential path to further regulate the thickness of the developer carried by the developer carrier;
an excess developer conveyance path that extends between the non-magnetic regulator and the secondary regulator, to convey an amount of excess developer away from the developer carrier; and
a merging region located adjacent the stirring device where the toner supply path and the excess developer conveyance path merge, the merging region to control the supply of the toner from the toner supply path to the stirring device based, at least in part, on the excess developer conveyed via the excess developer conveyance path.

15. The developing device according to claim 14,
wherein the toner supply path comprises a toner drop port at the merging region to direct the toner to the stirring device, and
wherein the toner drop port has an opening area that is less than a smallest cross-sectional area of the excess developer conveyance path.
